(19) United States
(12) Patent Application Publication
(10) Pub. No.: US 2024/0336231 A1
(43) Pub. Date: Oct. 10, 2024

(54) WIPING SYSTEM AND CONTROL OF CLEANING FLUID INJECTION IN A WIPING SYSTEM

(71) Applicant: VALEO SYSTEMES D'ESSUYAGE, La Verriere (FR)

(72) Inventors: Frederic GIRAUD, La Verriere (FR); Alexandre FILLOUX, La Verriere (FR); Gerald CAILLOT, La Verriere (FR)

(73) Assignee: VALEO SYSTEMES D'ESSUYAGE, La Verriere (FR)

(21) Appl. No.: 18/293,502

(22) PCT Filed: Jul. 26, 2022
(86) PCT No.: PCT/EP2022/070976

§ 371 Date: Jan. 30, 2024

(30) Foreign Application Priority Data
Jul. 30, 2021 (FR) FR2108348
Jul. 30, 2021 (FR) FR2108355

(51) Int. Cl. B60S 1/52; B60S 1/56

(52) U.S. Cl. CPC B60S 1/524; B60S 1/56

(57) ABSTRACT

The present invention relates to a wiping system including an arm and a wiper blade configured to wipe a visibility zone of a windshield of the motor vehicle and capable of being driven by the arm and including at least one longitudinal channel, with a nozzle element in fluidic communication with the at least one longitudinal channel and configured to spray cleaning fluid toward at least one sensor arranged outside the visibility zone. The nozzle element is arranged in a longitudinal end zone of the wiper blade. An injection assembly is capable of injecting a cleaning fluid into the longitudinal channel under the control of a control unit. When the control unit determines that the arm or the wiper blade is in a given angular sector, the injection of cleaning fluid into the longitudinal channel is commanded.

### TECHNICAL FIELD

The present invention relates to a wiping system, notably for a motor vehicle, and in particular to the control of the injection of cleaning fluid into such a system.

### BACKGROUND OF THE INVENTION

It is known practice in the field of wiping systems for glazed surfaces, in particular for the windshield or rear window of a motor vehicle, to provide longitudinal channels in a wiper blade in order to spray cleaning fluid in front of the wiper blade onto a glazed surface of the vehicle, to enable cleaning of the window.

Wiping systems with two longitudinal channels are known, one for spraying cleaning fluid in front of the blade in a first wiping direction, and the other for spraying cleaning fluid in front of the blade in a second wiping direction.

Other wiping systems provide for a spray of fluid onto the window elsewhere than the blade: for example, some wiping systems, referred to as “wet arm”, provide for a spray from an arm which rotates the blade, or from a fixed position on a hood of the motor vehicle.

Motor vehicles increasingly include sensors, most of which have an optical surface. It is necessary to clean such an optical surface in order to improve the quality of the data acquired.

However, it is expensive and bulky to provide a dedicated cleaning system for each of the sensors of the vehicle.

There is therefore a need to allow the cleaning of glazed or optical surfaces of a vehicle, without increasing the number of cleaning systems, while simplifying the cleaning system to reduce its cost and its bulk, and while optimizing the use of cleaning fluid.

### SUMMARY OF THE INVENTION

The present invention relates to a wiping system comprising:
an arm;
a motor capable of rotating the arm;
a wiper blade configured to wipe a visibility zone of a windshield of the motor vehicle and capable of being driven by the arm and comprising at least one longitudinal channel, and at least one nozzle element, in fluidic communication with the at least one longitudinal channel and configured to spray cleaning fluid toward at least one sensor arranged outside the visibility zone, said nozzle element being arranged in a longitudinal end zone of the wiper blade;
an injection assembly capable of injecting a cleaning fluid into the longitudinal channel, said injection assembly comprising at least one pump;
a control unit capable of controlling the injection assembly in real time on the basis of position data concerning the arm or the wiper blade.

When the control unit determines that the arm or the wiper blade is in a given angular sector, the angular sector being smaller than, or more restricted than, an angular wiping range of the wiping system, the control unit is capable of controlling injection by the cleaning fluid injection assembly at least into the longitudinal channel.

The nozzle element can thus point in a direction other than toward the visibility surface of the windshield onto which other nozzle elements may be capable of spraying cleaning fluid. For example, the direction of spraying to-ward the sensor outside the visibility zone may be mainly in a longitudinal direction of the wiper blade, which means that the angle formed by the given direction with a longitudinal direction is smaller than the angle formed by the given direction with a direction normal to the longitudinal direction. This makes it possible to clean an optical surface of a motor vehicle sensor which the end zone of the wiper blade faces in a given angular sector.

According to one embodiment, the given angular sector may be deter-mined as a function of a geometry of the wiping system, a geometry of an optical surface of the sensor, and a relative position of the wiping system and the sensor, when the wiping system is mounted on a motor vehicle comprising the sensor, such that the nozzle element sprays cleaning fluid toward the optical surface of the sensor when the arm or the blade is positioned in the angular sector.

The injection of cleaning fluid into the longitudinal channel is thus optimized, since the fluid is only sprayed when the blade passes in front of or near the optical surface of the sensor. Such an angular sector may be predefined, but may also be configurable, as a function in particular of the addition or the movement of a sensor and its optical surface.

According to one embodiment of the invention, the position data concerning the arm or the blade may come from the motor or may come from a detection device.

The use of position data coming from the motor of the wiping system makes it possible to limit the number of detection devices used, while having real-time data on the position and speed of the arm or the wiper blade.

According to embodiments, the wiper blade may comprise at least one other longitudinal channel and at least one other nozzle element in fluidic communication with the other longitudinal channel and capable of spraying cleaning fluid onto the visibility zone in a direction inclined relative to a longitudinal direction of the blade, and the injection assembly may be capable of selectively injecting the cleaning fluid into the longitudinal channel and/or into the other longitudinal channel.

The direction inclined relative to the longitudinal direction of the blade may in particular be normal to the longitudinal direction of the blade, or form a small angle, less than 20°, relative to a normal to the longitudinal direction of the blade.

In addition, according to embodiments, the other longitudinal channels comprise at least a first longitudinal channel and a second longitudinal channel, and the longitudinal channel is a third longitudinal channel. The other nozzle elements comprise at least a first nozzle element in fluidic communication with the first longitudinal channel and configured to spray cleaning fluid in a first direction inclined relative to a longitudinal direction of the blade and at least a second nozzle element in fluidic communication with the second longitudinal channel and configured to spray cleaning fluid in a second direction inclined relative to a longitudinal direction of the blade, and the nozzle element is a third nozzle element. The injection element may be capable of selectively injecting the cleaning fluid into the first longitudinal channel, the second longitudinal channel and/or the third longitudinal channel.

According to one embodiment of the invention, the injection assembly may comprise a first pump connected to the first longitudinal channel by a first injection channel, a second pump connected to the second longitudinal channel by a second injection channel and a third pump connected to the third longitudinal channel by a third injection channel, the control unit being capable of selectively activating the first, second and third pumps.

Such an embodiment allows each of the pumps to be controlled independently by the control unit. It is thus possible to inject cleaning fluid at different pressure levels into each of the pumps.

Alternatively, the injection assembly may comprise a first dual-pressure pump capable of injecting cleaning fluid into a first injection channel according to at least a first pressure level or a second pressure level, and a pressure differential valve connecting the injection channel to the first longitudinal channel or to the second longitudinal channel depending on whether the fluid is injected with the first pressure level or the second pressure level into the injection channel. The control unit may be capable of controlling the pressure level of the first dual-pressure pump.

This makes it possible to reduce the number of pumps in the injection assembly by sharing a pump for injection into the first and second longitudinal channels. Moreover, it is not necessary to inject fluid into these two channels at the same time since they may be dedicated to different wiping directions. The bulk and cost associated with the wiping system are thus reduced.

In addition, the injection assembly may further comprise a second pump capable of injecting cleaning fluid into a second injection channel connected to the third longitudinal channel and the control unit may be capable of controlling the activation of the second pump.

Injection into the third longitudinal channel is thus controlled independently of injection into the other two longitudinal channels. Thus, only two pumps are used in the injection system, while allowing selective injection into the longitudinal channels.

Alternatively, the first pump is a dual-pressure, two-way pump capable of selectively injecting cleaning fluid into the first injection channel or into a second injection channel connected to the third longitudinal channel, depending on a direction of rotation of a pump motor of the first pump. The control unit may be capable of controlling the direction of rotation of the pump motor of the first pump.

Thus, a single pump is used for injection into the three longitudinal channels, which considerably reduces the bulk associated with the system, while allowing selective injection.

Also alternatively, the first pump may be connected to a solenoid valve via a single channel, the solenoid valve being capable of transmitting the cleaning fluid injected by the first pump into the single channel, toward the first injection channel or toward a second injection channel connected to the third longitudinal channel, depending on control signals received from the control unit.

Again, a single pump is used for injection into the three longitudinal channels, which considerably reduces the bulk associated with the system, while allowing selective injection.

Alternatively, the injection assembly may comprise a first two-way pump, the first pump being connected to the first longitudinal channel by a first injection channel and being connected to the second longitudinal channel by a second injection channel, the first pump being capable of injecting cleaning flu-id into the first injection channel or into the second injection channel depending on a direction of rotation of a pump motor of the first pump. The injection sys-tem may further comprise a second pump connected to the third longitudinal channel by a third injection channel, the control unit being capable of control-ling the activation of the second pump.

It is thus possible to reduce the number of pumps to two pumps, while allowing selective injection of the cleaning fluid between the three longitudinal channels.

A second aspect of the invention relates to a method for controlling the injection of cleaning fluid into a wiping system for a motor vehicle, the wiping system comprising an arm, a motor capable of rotating the arm and a wiper blade configured to wipe a visibility zone of a windshield of the motor vehicle and capable of being driven by the arm and comprising at least one longitudinal channel, and at least one nozzle element, in fluidic communication with the at least one longitudinal channel and configured to spray cleaning fluid toward at least one sensor arranged outside the visibility zone, the nozzle element being arranged in a longitudinal end zone of the wiper blade;
the method comprising the following steps, implemented by a control unit:
real-time reception of position data concerning the arm or the wiper blade;
generation of control signals, on the basis of the position data, to control in real time the injection of cleaning fluid into the longitudinal channel;
transmission of the control signals to an injection assembly of the wiping system.

When the control unit determines that the arm or the wiper blade is in a given angular sector, the angular sector being smaller than an angular wiping range of the wiping system, the control signals generated control injection by the cleaning fluid injection assembly at least into the longitudinal channel.

### BRIEF DESCRIPTION OF DRAWINGS

Further features and advantages of the invention will become more clearly apparent both from the following description and from several exemplary embodiments, which are given by way of nonlimiting indication with reference to the attached schematic drawings, in which:

FIG. 1 depicts a wiping system according to an embodiment of the invention;

FIG. 2 shows a view in cross section of a wiper blade of a wiping system according to an embodiment of the invention;

FIG. 3 depicts a wiping system according to the invention, mounted on a windshield of a motor vehicle;

FIG. 4a depicts an injection assembly of a wiping system according to a first embodiment of the invention;

FIG. 4b depicts an injection assembly of a wiping system according to a second embodiment of the invention;

FIG. 4c depicts an injection assembly of a wiping system according to a third embodiment of the invention;

FIG. 4d depicts an injection assembly of a wiping system according to a fourth embodiment of the invention;

FIG. 4e depicts an injection assembly of a wiping system according to a fifth embodiment of the invention; and

FIG. 5 depicts a method for controlling the injection of cleaning fluid into a wiping system, according to embodiments of the invention.

### DETAILED DESCRIPTION OF THE INVENTION

It should first of all be noted that, although the figures set out the invention in detail for the implementation thereof, they may of course be used to better define the invention, where appropriate. It should also be noted that, in all of the figures, components that are similar and/or perform the same function are indicated using the same numbering.

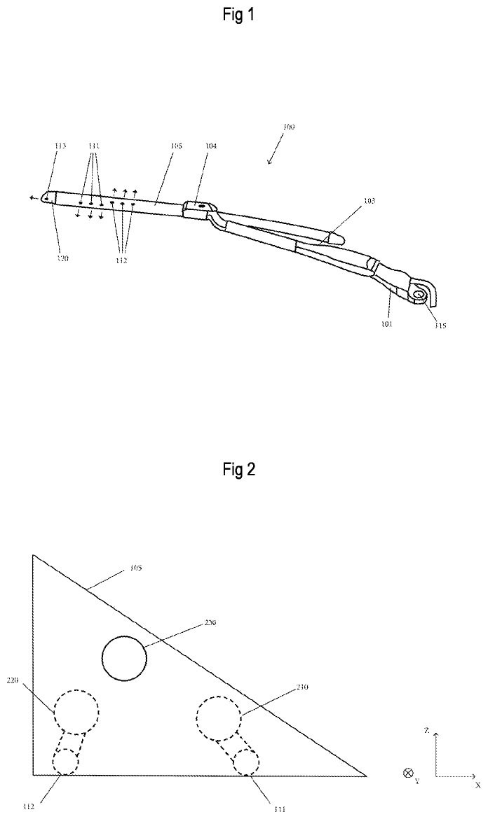

FIG. 1 depicts a wiping system 100 for a motor vehicle according to an embodiment of the invention. The wiping system is suitable for being installed on a glazed surface of a vehicle, preferably a windshield, or a rear window.

The wiping system comprises at least one arm 103, a wiper blade 105 attached to the arm by an attachment device 104 and configured to wipe a visibility zone of the windshield of the vehicle, and a drive device 101 for the arm 103.

A visibility zone is a part of the windshield positioned facing a driver or a passenger of the vehicle, and through which the passenger or the driver can see the environment outside the vehicle.

The drive device 101 is configured to set the wiper blade 104 in motion via the arm 103, the wiper blade 105 being in contact with the visibility zone. The movement of the arm 103 is typically a back and forth movement, preferably a circular movement. To this end, the drive device 101 may itself be moved by a motor about a pivot connection 101 making it possible to perform the circular movement of the wiping system 100.

No restriction is imposed on the attachment device 104, which is adapted to allow mechanical attachment of the wiper blade 105 to the arm 103. Mechanical attachment may in particular be performed by clamping, by fitting together, or by any other means. No restriction is imposed on the degrees of freedom permitted by the mechanical connection produced by the attachment device 104.

The wiping system 100 according to the invention further comprises an assembly for injecting a cleaning fluid from a reservoir, not shown in FIG. 1 but described below, toward the arm 103, then toward the wiper blade 105, in order to selectively distribute the cleaning fluid into at least one longitudinal channel in fluidic communication with at least one nozzle element 113 configured to spray or disperse cleaning fluid toward an optical surface of a sensor located outside the visibility zone, in a direction mainly in the longitudinal direction of the wiper blade 115, as will be better understood on reading the following. To this end, the nozzle element 113 may be arranged in a longitudinal end zone 120 of the wiper blade 105, in particular at the longitudinal end oriented upward when the wiping system is mounted on the windshield. The term “longitudinal end zone” means a zone all of the positions of which are closer to the longitudinal end of the wiper blade than to a central position of the wiper blade. The central position may in particular correspond to the position of the attachment device 104 between the wiper blade 105 and the arm 103 of the wiping system. Preferably, the longitudinal end zone includes all of the positions which are twice as close, or even three times as close, to the longitudinal end as to the central position of the wiper blade.

The nozzle element 113 may comprise an inlet for receiving the cleaning fluid from the conveying assembly, and at least one opening for spraying the cleaning fluid, for example two openings. When the nozzle element 113 comprises two openings, two longitudinal channels 230 may be provided in the wiper blade 103 to supply each of the openings of the nozzle element 113.

Below, by way of illustration, the longitudinal channel in fluidic communication with the nozzle element 113 arranged in the longitudinal end zone is considered to be a third longitudinal channel, the injection assembly also being capable of selectively distributing the cleaning fluid
into a first longitudinal channel in fluidic communication with first nozzle elements 111 for spraying or dispersing cleaning fluid over the visibility zone in a downward wiping direction;
into a second longitudinal channel in fluidic communication with second nozzle elements 112 for spraying or dispersing cleaning fluid over the visibility zone in a downward wiping direction. An upward direction may correspond to a wiping movement from the hood of the vehicle toward the roof. This ensures that the cleaning fluid is always sprayed in front of the wiper blade 105. This makes it possible to improve the driver's visibility through the visibility zone of the windshield and to make wiping by the wiper blade 105 more efficient.

The nozzle element 113 is thus referred to below as the third nozzle element 113.

No restriction is imposed on the structure of such nozzle elements, which are well known to those skilled in the art.

Note that the first and second longitudinal channels and the second and third nozzle elements 111 and 112 are optional and correspond to a given embodiment, in which the wiper blade is capable of spraying the cleaning fluid onto the visibility zone to be wiped in two different wiping directions. The wiper blade 105 is then referred to as a “dual sprayer” wiper blade.

Alternatively, the wiper blade 105 may comprise, in addition to the third longitudinal channel, only one of the first and second longitudinal channels leading to at least one nozzle element, such as the first nozzle element 111 or the second nozzle element 112, capable of spraying cleaning fluid onto the glazed surface in a downward and/or upward direction. The wiper blade thus comprises two longitudinal channels.

Also alternatively, the wiper blade 105 only comprises the longitudinal channel connected to the nozzle element 113 arranged in the longitudinal end zone of the wiper blade. In this case, spraying of the cleaning fluid onto the glazed surface may be ensured by nozzle elements located in the arm 103, and not in the wiper blade 105. Also alternatively, the system 100 comprises a nozzle element in a fixed position on the hood of the vehicle, capable of spraying cleaning fluid onto the glazed surface.

Below, the invention is described in the context of a dual sprayer wiper blade 105 comprising two longitudinal channels for spraying fluid onto the visibility zone, and the third longitudinal channel for spraying the sensor. It will be understood that such a context is presented for illustrative purposes only, and the nozzle elements capable of spraying cleaning fluid onto the glazed surface may be placed elsewhere than in the wiper blade 105, in the arm 103 or on the hood in particular.

According to the context described below, the nozzle elements are all arranged in the wiper blade 105.

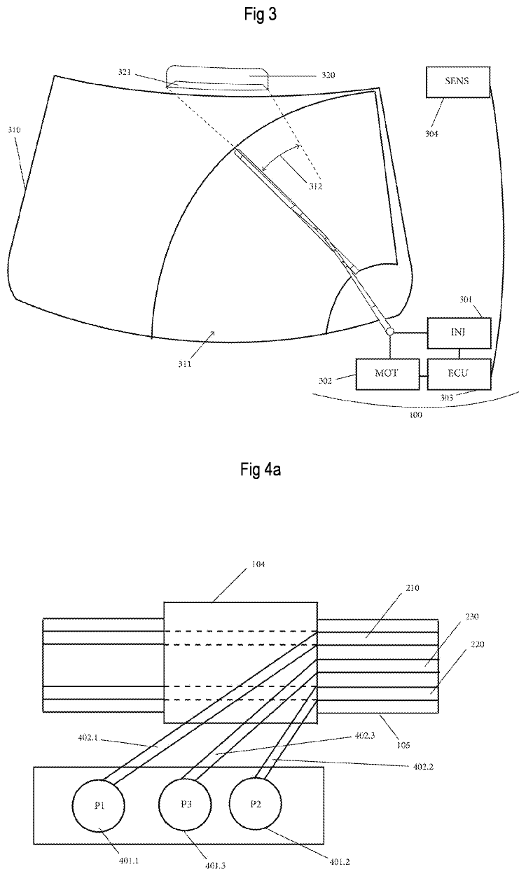

The blade 105 comprises at least three longitudinal channels shown with reference to FIG. 2.

FIG. 2 depicts a cross section through a wiper blade 105 of a wiping system 100 according to an embodiment of the invention.

The section is thus along a plane X-Z normal to a longitudinal direction Y of the wiper blade 105 shown in FIG. 1.

A wiper blade 105 of triangular section is shown in FIG. 2 merely by way of illustration. It will be understood that the wiper blade 105 may have a cross section of different shape.

A first longitudinal channel 210 is capable of conveying the cleaning fluid toward the first nozzle elements 111 described above, in particular in a downward wiping direction of the wiper blade 105.

A second longitudinal channel 220 is capable of conveying the cleaning fluid toward the second nozzle elements 112 described above, in particular in an upward wiping direction of the wiper blade 105.

Thus, in the embodiments in which the nozzle elements 111 and 112 are in the arm 103 or on the hood, the wiper blade does not include the first and second longitudinal channels 210 and 220.

A third longitudinal channel 230 is capable of conveying the cleaning fluid toward the third nozzle element 113 described above, when the movable part of the wiping system, namely the arm or the blade, is in a given angular sector, defining a set of positions, as will be explained more clearly below. The third nozzle element 113 may be capable of dispersing or spraying the cleaning fluid in a mainly longitudinal direction, therefore mainly parallel to the plane Y-X, for example substantially along the axis Y. Alternatively, the third nozzle element 113 may also spray obliquely with an inclination directed toward the glazed surface.

It is thus advantageous for the third channel 230 to be in a central position relative to the other two channels 210 and 220. The third channel 230 may in particular be further away from the glazed surface than the other two channels 210 and 220, along the axis Z, when the wiping system 100 is installed in a vehicle.

As shown in FIG. 2, the spraying directions of the first and second nozzle elements are preferably oblique to the visibility zone to be wiped extending mainly in the plane X-Y, so as to spray the glazed surface before it is wiped by the wiper blade 105.

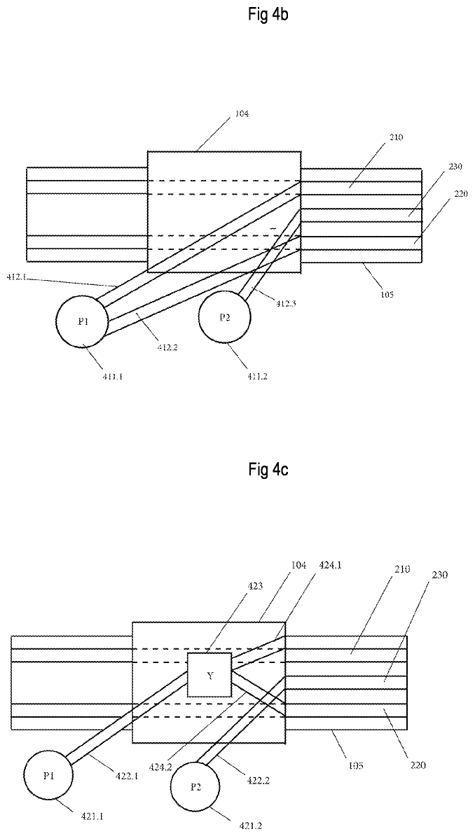

FIG. 3 shows a wiping system 100 mounted on a windshield 310 of a motor vehicle according to an embodiment of the invention.

As shown, the wiping system 100 may further comprise a motor 302 for driving the arm 105, a control unit 303 and an injection assembly 301 for injecting the fluid into the conveying assembly.

No restriction is imposed on the motor 302, which includes any reversible motor making it possible to rotate the movable part of the wiping system 100 in one direction then in another.

As will be understood more clearly on reading the description of the following figures, the injection assembly 301 may comprise elements mounted on the arm 105 and/or on the hood of the vehicle.

No restriction is imposed on the control unit 303, which may be a dedicated control unit of the wiping system 100, or which may be a central control unit of the vehicle, also called the ECU, which stands for “Electronic Control Unit”, or the “Body Controller”.

The ECU 303 is capable of receiving, according to the invention, position data concerning the movable part of the wiping system, including in particular the arm 103 and the wiper blade 105. Such position data are preferably received regularly, at a frequency greater than around ten hertz, when the wiping system 100 is activated.

The position data may be received from the motor 302, or alternatively from a detection device 304 capable of detecting the position of the movable part of the wiping system. No restriction is imposed on the detection device 304, which may be a camera for example.

The position data may include:
an angular position of the arm 103 and/or the wiper blade 105 within a predetermined range of wiping angles 311 corresponding to a visibility zone of the windshield; and/or
a speed of rotation of the arm 103 and/or the wiper blade 105.

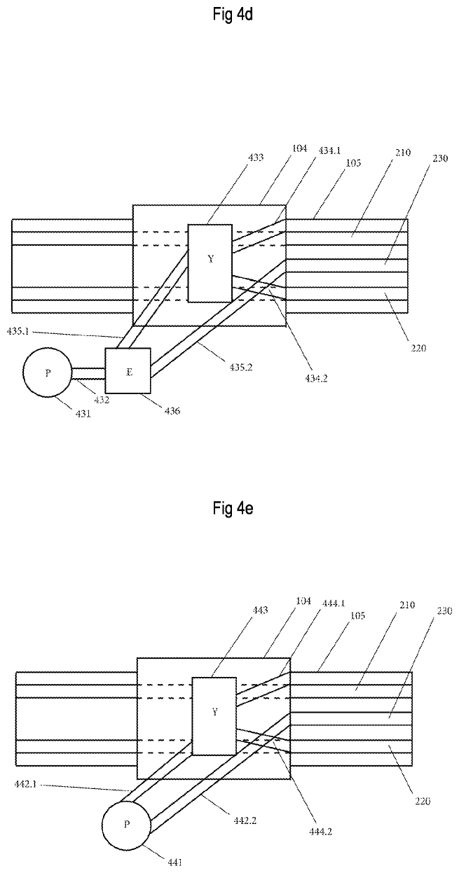

The injection assembly 301 is capable of selectively injecting cleaning fluid into the third longitudinal channel 230, that is to say it may inject or not inject cleaning fluid into the third longitudinal channel 230, on the basis of control signals. In the example with three longitudinal channels in the wiper blade, the injection assembly 301 is capable of selectively injecting cleaning fluid into one or more of the longitudinal channels 210, 220 and 230. Embodiments of such injection assemblies 301 will be presented with reference to FIGS. 4a to 4e. In particular, the injection assembly 301 is capable of injecting fluid into a single one or into two of the longitudinal channels 210, 200 and 230, at a given instant (or over a time range between consecutive receptions of position data).

The selection of one or two longitudinal channels 210, 220 and 230 depends on control signals transmitted by the control unit 303.

The control unit 303 determines such control signals on the basis of the position data received either from the motor 302 or from the detection device 304. In particular, the control unit 303 may determine, on the basis of the position data, whether the wiper blade 105 is wiping in an upward or downward direction. It then emits control signals to the injection unit 301:
to inject cleaning fluid into the first longitudinal channel 210 when the blade 105 is in a downward wiping direction;
to inject cleaning fluid into the second longitudinal channel 220 when the blade 105 is in a downward wiping direction.

Thus, preferably, at a given instant, cleaning fluid is never injected both into the first longitudinal channel 210 and into the second longitudinal channel 220.

As the change in wiping direction approaches, when the speed of the blade 105 becomes low in absolute value before becoming zero, the injection of cleaning fluid into the first and second longitudinal channels 210 and 220 may be suspended.

According to the invention, the control unit 330 is configured to control the injection of cleaning fluid by the injection assembly 301, into the third longitudinal channel 230, when the arm 103 and/or the wiper blade 105 is located in an angular sector 312 strictly included in the angular range 311 described above. The angular sector may in particular be less than 30°, for example less than 20°.

The angular sector 312 is defined such that the wiping system sprays cleaning fluid via the third nozzle element 113 toward an optical surface 321 of a sensor 320 of the vehicle located outside the visibility zone of the windshield. No restriction is imposed on the sensor 320 in question, which may be a lidar for example, nor on the position of this sensor 320. By way of example, in FIG. 3, a lidar type sensor is shown, in a position centered above the windshield 310 of the vehicle.

Thus, the angular sector 312 makes it possible to define a set of positions in which the third nozzle element 113 is facing a part of the optical surface 321 of the sensor 320, or is approaching the optical surface.

The angular sector 312 may advantageously depend on:
geometric characteristics of the wiping system, in particular of the arm 103 and of the wiper blade 105;
geometric characteristics of the optical surface 321;
the respective positioning between the wiping system 100 and the optical surface 321;
the part of the optical surface 321 to be cleaned. To be specific, the angular sector 312 may be defined to spray cleaning fluid onto only a part of the optical surface 321, for example onto a central part; and/or
the wiping speed of the wiping system 100. The control signals may thus trigger injection of the product before the third nozzle element 113 is facing the optical surface 321.

The control unit 303 may control the injection assembly 301 so as to inject cleaning fluid into the third longitudinal channel:
when the arm and/or the wiper blade 105 is in the angular sector 312, in the upward wiping direction;
when the arm and/or the wiper blade 105 is in the angular sector 312, in the downward wiping direction; and/or
when the arm and/or the wiper blade 105 is in the angular sector 312, regardless of the wiping direction.

This makes it possible to allow cleaning of an optical surface of a sensor located near a glazed surface on which a wiping system is mounted, without having to add a cleaning device especially for the sensor, while optimizing the consumption of cleaning fluid.

As shown in FIG. 3, the wiping system comprises a single arm/wiper blade assembly. However, it may comprise two such assemblies, one being located on the driver side, the other on the passenger side. The two assemblies may be controlled by the control unit 303 in the manner described above. Alternatively, only one of these assemblies comprises a nozzle element 113 and a longitudinal channel 230. It may for example be the passenger side arm/blade assembly, or alternatively, the driver side arm/blade assembly.

The embodiments described below differ in terms of the cleaning fluid injection assembly 301. Again, these embodiments are all described in the context of a dual sprayer blade 103 with three longitudinal channels. It will be understood, however, that the injection assembly 301 is more generally capable of selectively injecting cleaning fluid into the longitudinal channel 230 making it possible to clean the sensor, that is to say capable of injecting or not injecting fluid into the longitudinal channel 230. In a complementary manner, the injection assembly 301 may also be capable of selectively controlling the injection of cleaning fluid into one or more other longitudinal channels of the wiper blade 105, in the context of a single sprayer blade or dual sprayer blade, in a fixed nozzle element on the vehicle hood or in a nozzle element of the arm 103.

FIG. 4a presents a first fluid injection assembly 301 of a wiping system according to a first embodiment of the invention.

In the first embodiment, the injection assembly 301 comprises:
a first pump 401.1 and a first injection channel 402.1 capable of injecting cleaning fluid from a cleaning fluid reservoir into the first longitudinal channel 210;
a second pump 401.2 and a second injection channel 402.2 capable of injecting cleaning fluid from the cleaning fluid reservoir into the second longitudinal channel 220;
a third pump 401.3 and a third injection channel 402.3 capable of injecting cleaning fluid from the cleaning fluid reservoir into the third longitudinal channel 230.

No restriction is imposed on the type of pumps 401.1 to 401.3. The pumps may be selectively activated/deactivated by the control signals from the control unit 303 in order to carry out the control functions described with reference to FIG. 3.

It will thus be understood that the control unit 303 can, via control signals:
activate the first pump 401.1 in the downward wiping direction;
activate the second pump 401.2 in the upward wiping direction;
activate the third pump 401.3 in the angular sector 312, in an upward direction and/or in a downward direction.

The injection channels 402.1 to 402.3 are preferably connected to the arm 103, or integrated under protection of the arm 103, so as not to hinder wiping by the movable part of the wiping system 100. The same goes for the injection channels presented in the embodiments of the figures below. The longitudinal channels 210, 220 and 230 may join up with the injection channels 402.1 to 402.3 within the attachment device 104.

FIG. 4b presents a second fluid injection assembly 301 of a wiping system according to a second embodiment of the invention.

In the second embodiment, the injection assembly 301 comprises:
a first pump 411.1 associated with a first injection channel 412.1 and with a second injection channel 412.2, capable of injecting cleaning fluid from a cleaning fluid reservoir into the first longitudinal channel 210 or into the second longitudinal channel 220. To this end, the first pump 411.1 may be a two-way pump capable of injecting cleaning fluid into the first injection channel 412.1 or into the second injection channel 412.2, depending on a direction of rotation of a motor of the first pump 411.1;
a second pump 411.2 and a third injection channel 412.3 capable of injecting cleaning fluid from the cleaning fluid reservoir into the third longitudinal channel 230.

The pumps may be controlled by the control unit 303 in the manner described with reference to FIG. 3.

It will thus be understood that the control unit 303 can, via control signals:
activate the motor of the first pump 411.1 in a first direction of rotation, when the wiping system is wiping in the downward direction;
activate the motor of the first pump 411.1 in a second direction of rotation, when the wiping system is wiping in the upward direction;
activate the second pump 411.2 when the wiping system 100 is in the angular sector 312, in an upward direction and/or in a downward direction.

This makes it possible to reduce the number of pumps in the wiping system, which reduces the bulk as well as costs. Moreover, the first two-way pump 412.1 is advantageously shared between the first and second longitudinal channels 210 and 220, no simultaneous injection being necessary between these two longitudinal channels.

FIG. 4c presents a third fluid injection assembly 301 of a wiping system according to a third embodiment of the invention.

In the third embodiment, the injection assembly 301 comprises:
a first pump 421.1, a first injection channel 422.1 connecting the first pump 421.1 to a pressure differential valve 423, the pressure differential valve 423 being connected via a first distribution channel 424.1 to the first longitudinal channel 210, and via a second distribution channel 424.2 to the second longitudinal channel 220. The pressure differential valve 423, also called a “Y valve”, is capable of directing the fluid from the first injection channel 422.1 toward the first distribution channel 424.1 or toward the second distribution channel 424.2, depending on the pressure of the fluid in the first injection channel 422.1. The first pump 421.1 is capable of varying the injection pressure of the cleaning fluid in order to select one or other of the injection channels 422.1 and 422.2. This is referred to as a dual-pressure pump;
a second pump 411.2 and a second injection channel 422.2 capable of injecting cleaning fluid from the cleaning fluid reservoir into the third longitudinal channel 230.

The pumps 421.1 and 421.2 may be controlled by the control unit 303 in the manner described with reference to FIG. 3.

It will thus be understood that the control unit 303 can, via control signals:
activate the motor of the first pump 421.1 to inject the cleaning fluid with a first pressure level into the first injection channel 422.1, when the wiping system is wiping in the downward direction;
activate the motor of the first pump 421.1 to inject the cleaning fluid with a second pressure level into the first injection channel 422.1, when the wiping system is wiping in the upward direction;
activate the second pump 421.2 when the wiping system 100 is in the angular sector 312, in an upward direction and/or in a downward direction.

Thus, the number of pumps is reduced compared to the first embodiment, and the number of injection channels is reduced compared to the second embodiment, which reduces the bulk associated with the injection assembly 301.

FIG. 4d presents a fourth fluid injection assembly 301 of a wiping system according to a fourth embodiment of the invention.

In the fourth embodiment, the injection assembly 301 comprises:
a single pump 431 connected by a single channel 432 to a solenoid valve 436 capable of being controlled to connect the single channel 432 to a first injection channel 435.1 or to a second injection channel 435.2, or to both injection channels 435.1 and 435.2. The pump 431 and the solenoid valve 436 are both controlled by the control unit 303. The solenoid valve 436 thus acts as a switch between the two injection channels 435.1 and 435.2 and the single channel 432, and may be controlled by control signals;
a pressure differential valve 433, connected via a first distribution channel 434.1 to the first longitudinal channel 210, and via a second distribution channel 434.2 to the second longitudinal channel 220. The Y valve 433 is capable of directing the fluid from the first injection channel 435.1 toward the first distribution channel 434.1 or toward the second distribution channel 434.2, depending on the pressure of the fluid in the first injection channel 435.1. The pump 431 is thus capable of varying the injection pressure of the cleaning fluid in order to select one or other of the injection channels 422.1 and 422.2, when the solenoid valve 436 selects at least the first injection channel 435.1.

The pump 431 and the solenoid valve 436 may be controlled by the control unit 303 in the manner described with reference to FIG. 3.

It will thus be understood that the control unit 303 can, via control signals:
activate the motor of the pump 431 to inject the cleaning fluid with a first pressure level, and control the solenoid valve to select at least the first injection channel 435.1, when the wiping system is wiping in the downward direction;
activate the motor of the pump 431 to inject the cleaning fluid with a second pressure level, and control the solenoid valve to select at least the first injection channel 435.1, when the wiping system is wiping in the upward direction;
activate the motor of the pump 431 and control the solenoid valve 436 to select at least the second injection channel 435.2, when the wiping system 100 is in the angular sector 312, in an upward direction and/or in a downward direction.

Thus, the number of pumps is reduced compared to the first embodiment, a single dual-pressure pump being provided. The number of injection channels is also two as in the third embodiment. However, it is necessary to also provide an additional solenoid valve, compared to the previous embodiments.

FIG. 4e presents a fifth fluid injection assembly 301 of a wiping system according to a fifth embodiment of the invention.

In the fifth embodiment, the injection assembly 301 comprises:
a single pump 441, of dual-pressure, two-way type, connected by a first injection channel 442.1 to a pressure differential valve 443, and by a second injection channel 442.2 to the third longitudinal channel 230. The pump 441 is two-way in that it is capable of selectively injecting fluid into the first injection channel 442.1 or into the second injection channel 442.2, depending on the direction of rotation of the motor of the pump. Furthermore, it is capable of injecting cleaning fluid at least two different pressure levels;
the pressure differential valve 443, connected via a first distribution channel 444.1 to the first longitudinal channel 210, and via a second distribution channel 444.2 to the second longitudinal channel 220. The Y valve 443 is capable of directing the fluid from the first injection channel 442.1 toward the first distribution channel 444.1 or toward the second distribution channel 444.2, depending on the pressure of the fluid in the first injection channel 442.1. The pump 441 is thus capable of varying the injection pressure of the cleaning fluid in order to select one or other of the distribution channels 444.1 and 444.2, when the pump 441 rotates in a direction associated with injection into the first injection channel 442.1.

The pumps 441.1 and 441.2 may be controlled by the control unit 303 in the manner described with reference to FIG. 3.

It will thus be understood that the control unit 303 can, via control signals:
activate the motor of the pump 441 in a first direction to inject the cleaning fluid with a first pressure level, when the wiping system is wiping in the downward direction;
activate the motor of the pump 441 in the first direction to inject the cleaning fluid with a second pressure level, when the wiping system is wiping in the upward direction;
activate the motor of the pump 441 in a second direction to select the second injection channel 435.2, when the wiping system 100 is in the angular sector 312, in an upward direction and/or in a downward direction.

The fifth embodiment thus makes it possible to limit as much as possible the number of elements of the injection assembly 301, while allowing selective injection into the longitudinal channels 210, 220 and 230. The bulk associated with the injection assembly is thus reduced.

More generally than in the embodiments described, which all refer to a context of a dual sprayer wiper blade with three longitudinal channels, the control unit 303 is capable of selectively controlling the injection of cleaning fluid into the third longitudinal channel 230 in the given angular sector, via at least one pump of the injection assembly 301.

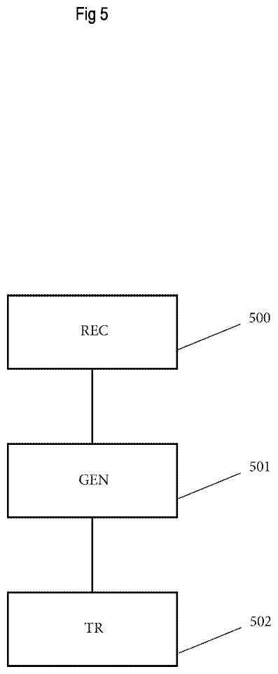

FIG. 5 is a diagram illustrating the steps of a method for controlling the injection of cleaning fluid implemented by a control unit 303 of a wiping system 100 according to the invention.

In a step 500, the control unit 303 receives, in real time, position data concerning the arm 103 or the blade 105. No restriction is imposed on the frequency with which position data is received in real time. Such a frequency is preferably greater than 10 Hz, or even 100 Hz.

In a step 501, the control unit 303 generates control signals to selectively control the injection of cleaning fluid into the longitudinal channel 230, on the basis of the position data received. The control signals are generated in the manner described above, according to the position of the arm 103 or the blade 105 relative to the given angular sector.

In a complementary manner, in the context of a dual sprayer wiper blade, the control unit 303 generates control signals to selectively control the injection of cleaning fluid into the first longitudinal channel 210, into the second longitudinal channel 220 and/or into the third longitudinal channel 230, depending on the position data received. The control signals are generated in the manner described above, according to the direction of wiping of the wiper blade 105 and according to the position of the arm 103 or the blade 105 relative to the given angular sector.

In a step 502, the control unit 303 transmits the control signals to the injection assembly 301.

Depending on the embodiment, the injection assembly 301 may vary, and the control signals may thus consist of:
pump activation/deactivation signals;
a level of injection pressure of a pump, when the pump is dual-pressure;
a direction of rotation of a pump motor, when a pump is two-way;
a solenoid valve control signal, when the injection assembly includes a solenoid valve.

Of course, the invention is not limited to the examples that have just been described and numerous modifications can be made to these examples without departing from the scope of the invention.

What is claimed is:

1. A wiping system for a motor vehicle, comprising:
an arm;
a motor capable of rotating the arm;
a wiper blade configured to wipe a visibility zone of a windshield of the motor vehicle and capable of being driven by the arm and including at least one longitudinal channel, and at least one nozzle element, in fluidic communication with the at least one longitudinal channel and configured to spray cleaning fluid toward at least one sensor arranged outside the visibility zone, the nozzle element being arranged in a longitudinal end zone of the wiper blade;
an injection assembly capable of injecting a cleaning fluid into the longitudinal channel, the injection assembly including at least one pump;
a control unit capable of controlling the injection assembly in real time on the basis of position data concerning the arm or the wiper blade,
wherein when the control unit determines that the arm or the wiper blade is in a given angular sector, the angular sector being smaller than an angular wiping range of the wiping system, the control unit is capable of controlling injection by the cleaning fluid injection assembly into the longitudinal channel.

2. The wiping system as claimed in claim 1, wherein the given angular sector is determined as a function of a geometry of the wiping system, a geometry of an optical surface of the sensor, and a relative position of the wiping system and the sensor, when the wiping system is mounted on a motor vehicle including the sensor, such that the nozzle element sprays cleaning fluid toward the optical surface of the sensor when the arm or the blade is positioned in the angular sector.

3. The wiping system as claimed in claim 1, wherein the position data concerning the arm or the blade come from the motor or come from a detection device.

4. The wiping system as claimed in claim 1, wherein the wiper blade includes at least one other longitudinal channel and at least one other nozzle element in fluidic communication with the other longitudinal channel and configured to spray cleaning fluid onto the visibility zone coming from the other longitudinal channel in a direction inclined relative to a longitudinal direction of the blade;
wherein the injection assembly is capable of selectively injecting the cleaning fluid into the longitudinal channel and/or into the other longitudinal channel.

5. The wiping system as claimed in claim 4, wherein the at least one other longitudinal channel comprises at least a first longitudinal channel and a second longitudinal channel, and wherein the longitudinal channel is a third longitudinal channel,
wherein the at least one other nozzle element comprises at least a first nozzle element in fluidic communication with the second longitudinal channel and configured to spray cleaning fluid in a first direction inclined relative to a longitudinal direction of the blade and at least a second nozzle element in fluidic communication with the third longitudinal channel and configured to spray cleaning fluid in a second direction inclined relative to a longitudinal direction of the blade, and wherein the nozzle element is a third nozzle element;
wherein the injection element is capable of selectively injecting the cleaning fluid into the first longitudinal channel, the second longitudinal channel and/or the third longitudinal channel.

6. The wiping system as claimed in claim 5, wherein the injection assembly includes a first pump connected to the first longitudinal channel by a first injection channel, a second pump connected to the second longitudinal channel by a second injection channel and a third pump connected to the third longitudinal channel by a third injection channel, the control unit being capable of selectively activating the first, second and third pumps.

7. The wiping system as claimed in claim 5, wherein the injection assembly includes a first dual-pressure pump capable of injecting cleaning fluid into a first injection channel according to at least a first pressure level or a second pressure level, and a pressure differential valve connecting the first injection channel to the first longitudinal channel or to the second longitudinal channel depending on whether the fluid is injected with the first level or the second pressure level into the first injection channel;
wherein the control unit is capable of controlling the pressure level of the dual-pressure pump.

8. The wiping system as claimed in claim 7, further comprising a second pump capable of injecting cleaning fluid into a second injection channel connected to the third longitudinal channel, wherein the control unit is capable of controlling the activation of the second pump.

9. The wiping system as claimed in claim 7, wherein the first pump is a dual-pressure, two-way pump capable of selectively injecting cleaning fluid into the first injection channel or into a second injection channel connected to the third longitudinal channel, depending on a direction of rotation of a pump motor of the first pump;
wherein the control unit is capable of controlling the direction of rotation of the pump motor of the first pump.

10. The wiping system as claimed in claim 7, wherein the first pump is connected to a solenoid valve via a single channel, the solenoid valve being capable of transmitting the cleaning fluid injected by the first pump into the single channel, toward the first injection channel or toward a second injection channel connected to the third longitudinal channel, depending on control signals received from the control unit.

11. The wiping system as claimed in claim 5, wherein the injection system comprises a first two-way pump, the first pump being connected to the first longitudinal channel by a first injection channel and being connected to the second longitudinal channel by a second injection channel, the first pump being capable of injecting cleaning fluid into the first injection channel or into the second injection channel depending on a direction of rotation of a pump motor of the first pump;
wherein the injection assembly further comprises a second pump connected to the third longitudinal channel by a third injection channel, the control unit being capable of controlling the activation of the second pump.

12. A method for controlling the injection of cleaning fluid into a wiping system for a motor vehicle, the wiping system comprising an arm, a motor capable of rotating the arm and a wiper blade configured to wipe a visibility zone of a windshield of the motor vehicle and capable of being driven by the arm and comprising a longitudinal channel, and at least one nozzle element, in fluidic communication with the at least one longitudinal channel and configured to spray cleaning fluid toward at least one sensor arranged outside the visibility zone, the nozzle element being arranged in a longitudinal end zone of the wiper blade;
the method comprising, implemented by a control unit:
real-time reception of position data concerning the arm or the wiper blade;
generation of control signals, on the basis of the position data, to control in real time the injection of cleaning fluid into the longitudinal channel;
transmission of the control signals to an injection assembly of the wiping sys-tem;
wherein when the control unit determines that the arm or the wiper blade is in a given angular sector, the angular sector being smaller than an angular wiping range of the wiping system, the control signals generated control injection by the cleaning fluid injection assembly at least into the longitudinal channel.
